(19) United States
(12) Patent Application Publication
(10) Pub. No.: US 2016/0228823 A1
(43) Pub. Date: Aug. 11, 2016

(54) ION EXCHANGE MEMBRANE AND FILTER MODULE USING SAME

(71) Applicant: AMOGREENTECH CO., LTD., Gimpo-si (KR)

(72) Inventors: In Yong SEO, Seoul (KR); Jun Sik HWANG, Incheon (KR)

(21) Appl. No.: 15/097,579

(22) Filed: Apr. 13, 2016

Related U.S. Application Data
(63) Continuation-in-part of application No. PCT/KR2014/010824, filed on Nov. 12, 2014.

(30) Foreign Application Priority Data
Nov. 12, 2013 (KR) 10-2013-0136783

(51) Int. Cl. B01D 69/02; D04H 1/728; C02F 1/469; B01D 15/36; B01D 71/06; B32B 5/26; C02F 1/42; D01D 5/00; B01D 69/10

(52) U.S. Cl. CPC B01D 69/02; D01D 5/003; D04H 1/728; C02F 1/4691; C02F 1/4693; B01D 69/10; B01D 71/06; B32B 5/26; C02F 1/42; B01D 15/362; B01D 15/363; D10B 2505/04; C02F 2201/46; B01D 2323/39; B01D 2325/08; B01D 2325/42; B32B 2250/20; B32B 2262/02; C02F 2001/422; C02F 2001/425; C02F 2305/08

(57) ABSTRACT

Provided are an ion-exchange membrane and a filter module using the same. The ion-exchange membrane includes: a porous membrane that is formed by accumulating nanofibers obtained by electrospinning an ion-exchange solution, or a non-pore membrane that is formed by accumulating liquid droplets obtained by electrospraying an ion-exchange solution.

### TECHNICAL FIELD

The present invention relates to an ion-exchange membrane, and more particularly, to an ultra-thin ion-exchange membrane that is formed by electrospinning or electrospraying an ion-exchange solution, and a filter module using the same.

### BACKGROUND ART

In general, only 0.0086% of all the earth's water volume may be used. When considering disasters due to climate change in mind, water may not be available enough.

Water is very important to human life and is used variously as water for living or industrial water. Water may be contaminated with heavy metals, nitrate, fluoride, etc., due to industrial development and it is very harmful to health to drink contaminated water.

Recently, deionization technologies for purifying contaminated water and sea water for use as agricultural, industrial, or irrigation water have been variously studied.

These deionization technologies are techniques for deionization or deionization of water by removing various suspended solids or ion components contained in the sea water or polluted water such as waste water, and may employ an evaporation method to evaporate water by using a heat source such as fossil fuels or electric power, a filtration method to filter and remove foreign materials by using a separation membrane, or an electrodialysis method to remove ions by using an electrolytic action of an electrode cell.

The evaporation method evaporates moisture by using fossil fuels or electricity as a heat source, is inefficient due to the large volume of the deionization equipment, increases the manufacturing cost due to an increase in the consumption of energy, and causes contamination of air due to the use of fossil fuels.

The filtration method removes foreign matters by applying a high pressure to a separator and thus the cost of energy increases.

The electrodialysis method has to constantly replace an electrode cell with another, and does not only generate a waste factor due to the replacement of the electrode cell but also has the disadvantage of increasing human and material incidental expenses in accordance with the replacement of the electrode cell.

Korean Patent Registration Publication No. 501417 discloses a waste water deionization apparatus using a reverse osmosis membrane method/electrode method, the waste water deionization apparatus comprising: a reverse osmosis membrane device to primarily remove salt components from water to be treated in which the water to be treated is introduced with a predetermined pressure into the reverse osmosis membrane device; a deionization electrode device that secondarily removes salt components from the water that has been primarily processed in the reverse osmosis membrane device in which a spacer, a positive electrode and a negative electrode are sequentially provided in a cylindrical tank; an energy recovery device for utilizing a brine-side pressure of the reverse osmosis membrane device for use to pressurize inlet water of the deionization electrode device; a power supply device for supplying power to the positive electrode and the negative electrode provided in the deionization electrode device; and a controller for controlling valves provided in pipes through which the water to be process in order to perform a deionization process for deionizing the water to be treated in which the water to be treated is introduced into the deionization electrode device, and a reproduction process for desorbing ions adsorbed to the electrode during the deionization process. However, such a waste water deionization apparatus includes the reverse osmosis membrane device and the deionization electrode device individually and thus may cause the large size of the deionization apparatus and require a lot of manufacturing cost.

Thus, the present inventors have consistently proceeded with a study on a technique of implementing an ultra-thin membrane, to thus derive and invent methodical and structural features capable of applying a porous membrane to a chemical filter and a non-pore membrane to a deionization apparatus, to thereby have completed the present invention that is more economical, and possibly utilizable, and competitive.

### SUMMARY OF THE INVENTION

To solve the above problems or defects, it is an object of the present invention to provide an ion-exchange membrane configured into a membrane of a structure that is formed by electrospinning an ion-exchange solution and accumulating nanofibers of an ion-exchange material, to thereby perform a surface filtration achieved in a surface layer and a depth filtration achieved in an inner layer, and filter out particular ions of a chemical material included in water to be treated by using the ion-exchange material of the nanofibers, and a filter module using the same.

It is another object of the present invention to provide an ion-exchange membrane configured into a non-pore membrane that is formed by electrospraying an ion-exchange solution and accumulating sprayed liquid droplets, thereby omitting a drying step while achieving an ultra-thin film.

The objects of the present invention are not limited to the above-described objects, and other objects and advantages of the present invention can be appreciated by the following description and will be understood more clearly by embodiments of the present invention.

To accomplish the above and other objects of the present invention, according to an aspect of the present invention, there is provided an ion-exchange membrane comprising: a porous membrane that is formed by accumulating nanofibers obtained by electrospinning an ion-exchange solution, or a non-pore membrane that is formed by accumulating liquid droplets obtained by electrospraying an ion-exchange solution.

In addition, according to another aspect of the present invention, there is provided a flat plate-like filter module that is configured to have a flat plate-like structure that is formed by laminating a porous ion-exchange membrane with one or both of a nonwoven fabric and a polymer nanofiber web, or that is formed by repeatedly laminating the porous ion-exchange membrane, in which the porous ion-exchange membrane is formed by accumulating nanofibers obtained by electrospinning an ion-exchange solution.

In addition, according to still another aspect of the present invention, there is provided a pleat-like filter module that is configured to comprise a porous ion-exchange membrane that is formed by accumulating nanofibers obtained by electrospinning an ion-exchange solution, a tubular body with a throughhole formed therein, and pleats that are formed on side walls of the throughhole and an outer circumferential surface of the tubular body.

In addition, according to yet another aspect of the present invention, there is provided a spirally wound type filter module that is configured to have a spiral structure that is formed by spirally winding a structure that is formed by laminating a porous ion-exchange membrane with one or both of a nonwoven fabric and a polymer nanofiber web, or by spirally winding the porous ion-exchange membrane, in which the porous ion-exchange membrane is formed by accumulating nanofibers obtained by electrospinning an ion-exchange solution.

As described above, according to the present invention, a porous ion-exchange membrane is formed by laminating and arranging nanofibers obtained by electrospinning an ion-exchange material, to thereby have advantages of filtering nano-scale fine contaminants included in water to be treated when the water to be treated passes through micropores present in the porous ion-exchange membrane, and filtering ions of a chemical material with the ion-exchange material included in the nanofibers.

In addition, according to the present invention, a non-pore ion-exchange membrane of a uniform non-pore film form without having unnecessary pores may be formed by electrospinning an ion-exchange solution and accumulating the electrospun liquid droplets, to thus provide an effect capable of maximizing productivity since a separate drying process is unnecessary.

In addition, according to the present invention, a non-pore ion-exchange membrane of a non-pore film form of a dense structure may be implemented and may have an ultra-thin structure by electrospinning or electrospraying an ion-exchange solution, to thus have advantages that only selected ions can move freely and lower moving resistance of ions.

### DESCRIPTION OF DRAWINGS

FIG. 1 is a schematic cross-sectional view for explaining a method of producing a porous ion-exchange membrane according to a first embodiment of the present invention.

FIG. 2 is a conceptual view illustrating a porous ion-exchange membrane according to the first embodiment of the present invention.

FIG. 3 is a schematic cross-sectional view for explaining a method of manufacturing a non-pore ion-exchange membrane according to a second embodiment of the present invention.

FIG. 4 is a conceptual view illustrating a lamination structure of the ion-exchange membrane according to the first and second embodiments of the present invention.

FIG. 5 is a conceptual view illustrating another lamination structure of the ion-exchange membrane according to the first and second embodiments of the present invention.

FIGS. 6A and 6B are conceptual views illustrating still another lamination structure of the ion-exchange membrane according to the first and second embodiments of the present invention.

FIGS. 7A to 7C are conceptual perspective views illustrating an assembled state of a filter module with the porous ion-exchange membrane according to the first embodiment of the present invention.

### DETAILED DESCRIPTION OF THE INVENTION

Hereinafter, embodiments of the present invention will be described in detail with reference to the accompanying drawings. In the process, the size and shape of the components illustrated in the drawings may be exaggerated for convenience and clarity of explanation. Further, by considering the configuration and operation of the present invention, the specifically defined terms can be changed according to user's or operator's intention, or the custom. Definitions of these terms herein need to be made based on the contents across the whole application.

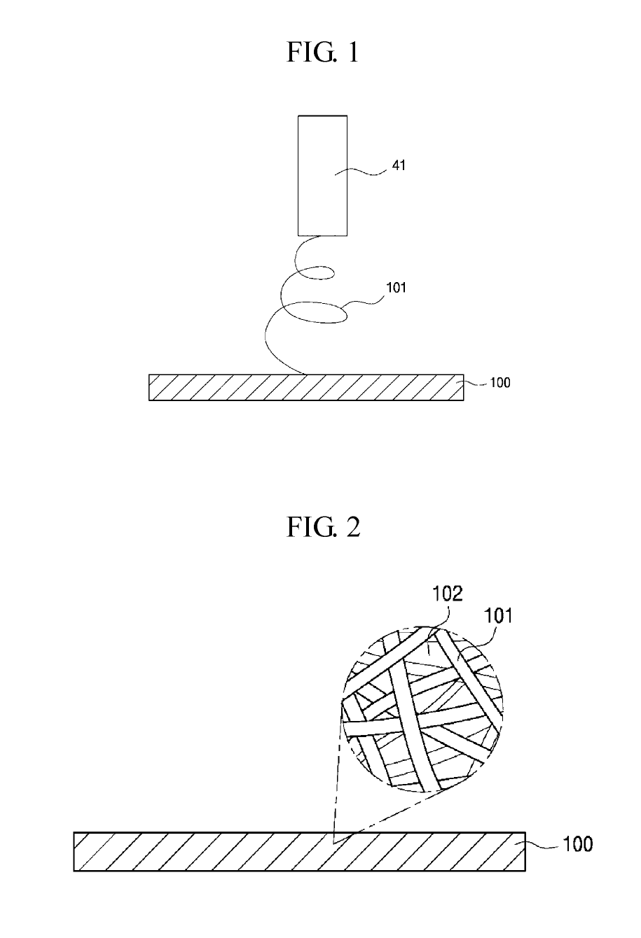

Referring to FIG. 1, according to a first embodiment of the present invention, a porous ion-exchange membrane 100 is formed by electrospinning an ion-exchange solution from a nozzle 41 and accumulating nanofibers 101 obtained by electrospinning the ion-exchange solution.

The porous ion-exchange membrane 100 is formed by irregularly accumulating the spun nanofibers 101. As shown in FIG. 2, a large number of fine pores 102 are formed between the nanofibers 101 of the porous ion-exchange membrane 100.

Thus, the porous ion-exchange membrane 100 filters nano-scale fine contaminants included in water to be treated when the water to be treated passes through micropores present in the porous ion-exchange membrane 100, and filters ions of a chemical material.

That is, the porous ion-exchange membrane 100 are made of nanofibers of the ion-exchange material, to thus perform a surface filtration achieved in a surface layer and a depth filtration achieved in an inner layer, and filter out particular ions of a chemical material included in water to be treated by using the ion-exchange material of the nanofibers.

Thus, the porous ion-exchange membrane 100 according to the first embodiment of the present invention may be used as a chemical filter capable of filtering impurities such as particulate matters, ionic substances, bacteria, and viruses from a liquid comprising water to be used in a process that is carried out in most of industrial fields.

Meanwhile, the ion-exchange solution contains ion exchangers such as SO₃⁻ and NH₃⁺, and the ion exchangers are attached to nanofibers of the porous ion-exchange membrane 100 that is formed by electrospinning the ion-exchange solution. Therefore, the present invention has an advantage of filtering fine ionic materials by adsorption performance of the ion exchangers without reducing the pore size. Here, the ion exchangers are negative ion exchangers or positive ion exchangers.

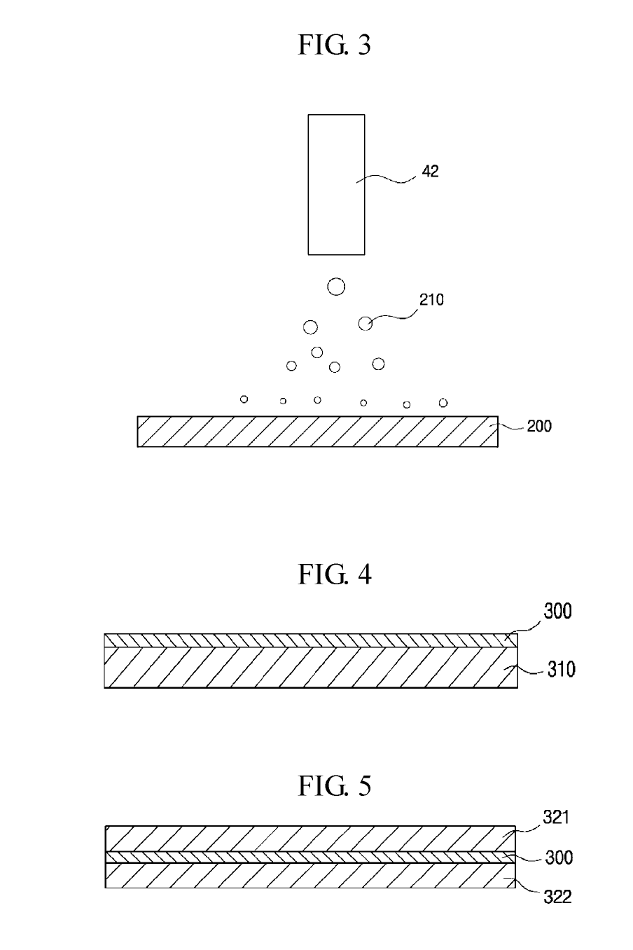

FIG. 3 is a schematic cross-sectional view for explaining a method of manufacturing a non-pore ion-exchange membrane ball according to a second embodiment of the present invention.

Referring to FIG. 3, according to the second embodiment of the present invention, a non-pore ion-exchange membrane 200 is formed by electrospinning an ion-exchange solution from a nozzle 42, and accumulating the sprayed liquid droplets 210.

That is, when the ion-exchange solution is electrosprayed, liquid droplets of fine size are sprayed from a nozzle 42 that electrosprays the ion-exchange solution, and the initially sprayed liquid droplets are fine-differentiated by electric power. In addition, the liquid droplets are sprayed from the nozzle and simultaneously a majority of a solvent is volatilized. Accordingly, only the liquid droplets 101 of the ion-exchange material are accumulated. Therefore, a non-pore ion-exchange membrane 200 of a uniform non-pore film form without having unnecessary pores may be formed to thus maximize productivity since a separate drying process is unnecessary.

In addition, in some embodiments of the present invention, a non-pore ion-exchange membrane 200 is formed by electrospraying an ion-exchange solution and accumulating the sprayed liquid droplets, to thereby have a non-pore film form of a dense structure and have an ultra-thin structure, to thus have advantages that only selected ions can move freely and lower moving resistance of ions.

Meanwhile, a polymer material and an ion-exchange solution may be mixed and electrosprayed to improve properties of matter, to thereby form a non-pore ion-exchange membrane 200. In this case, the non-pore ion-exchange membrane 200 is formed of a thin film in which the polymer material is mixed with the ion-exchange material.

In some embodiments of the present invention, the non-pore ion-exchange membrane 200 has a form that pores do not exist therein, thereby increasing selective permeability of ions. On the contrary, the ion-exchange membranes having pores have no preferred structures since both positive and negative ions can pass through the pores despite electrical attraction or repulsion.

The non-pore ion-exchange membrane 200 may be a positive ion-exchange membrane or a negative ion-exchange membrane according to polarities of electrodes, and the non-pore ion-exchange membrane 200 serves to selectively adsorb ions to the electrodes. That is, the negative ion-exchange membrane is coupled to a positive electrode, and the positive ion-exchange membrane is coupled to a negative electrode. Thus, when a voltage is applied across the positive electrode and the negative electrode, only positive ions are adsorbed in the negative electrode, and only negative ions are adsorbed in the positive electrode.

Therefore, since the non-pore ion-exchange membrane 200 is a non-porous thin film that is formed by accumulating liquid droplets formed by electrospraying the ion-exchange solution, the non-pore ion-exchange membrane 200 may be made very thin and uniform, to thereby improve adsorption and desorption efficiency of ions.

After the capacitive deionization device has adsorbed ions from one electrode, the non-pore ion-exchange membrane 200 is effective to prevent ions desorbed from the capacitive deionization device from being re-adsorbed to the other electrode.

Therefore, the non-pore ion-exchange membrane according to the second embodiment of the present invention may be applied to electric deionization devices such as CDI (Capacitive deionization), ED (Electrodialysis), EDR (Electrodialysis reversal), and RED (Reverse electrodialysis).

Referring to FIG. 4, the ion-exchange membrane 300 according to the first and second embodiments of the present invention may be configured to have a lamination structure laminated with a nonwoven fabric 310 to compensate for mechanical strength.

As shown in FIG. 5, the ion-exchange membrane 300 according to the first and second embodiments of the present invention may be interposed between a first polymer nanofiber web 321 and a second polymer nanofiber web 322 to improve properties of matter.

In addition, the ion-exchange membrane 300 according to the first and second embodiments of the present invention is formed on the polymer nanofiber web 320 and then be laminated with a nonwoven fabric 310.

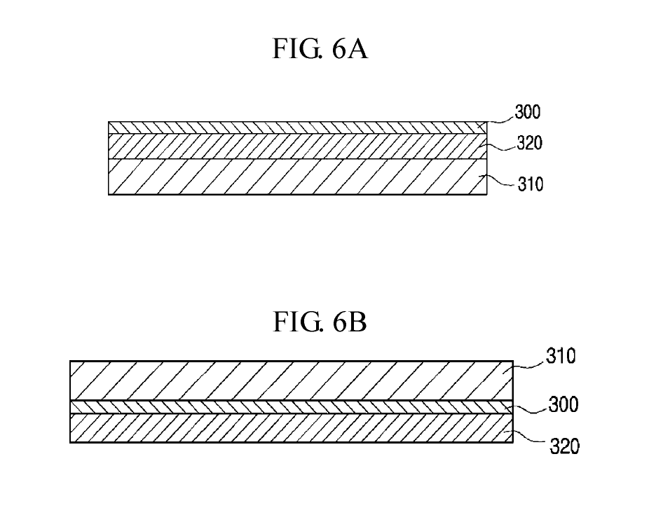

In this case, FIG. 6A illustrates a structure that a polymer nanofiber web 320 and an ion-exchange membrane 300 are sequentially laminated on a nonwoven fabric 310. Here, since a polymer nanofiber web 320 is in contact with and is laminated on the nonwoven fabric 310, a contact interface is formed between the polymer nanofiber web 320 and the nonwoven fabric 310.

In addition, FIG. 6B illustrates a structure that a polymer nanofiber web 320 and an ion-exchange membrane 300 are sequentially laminated on a nonwoven fabric 310, in which the ion-exchange membrane 300 is in contact with the nonwoven fabric 310.

Meanwhile, the porous ion-exchange membrane according to the first embodiment of the present invention as described above is excellent in flexibility by accumulating nanofibers of the ion-exchange material, to thus have very flexible characteristics, and to thereby implement a filter module of a variety of assembly shapes such as a flat plate-like filter module 510, a pleat-like filter module 520, and a spirally wound type filter module 530.

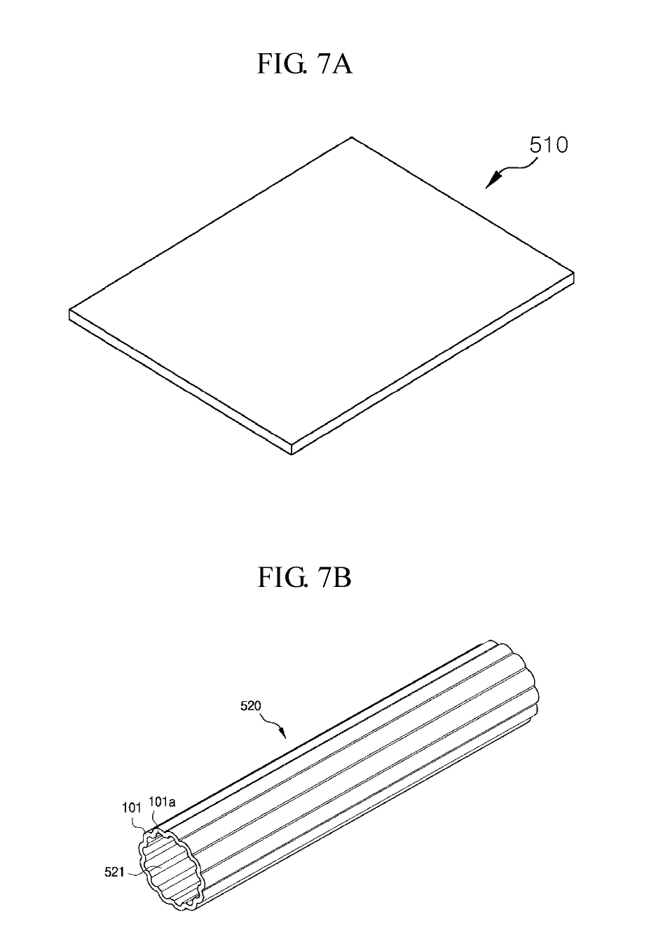

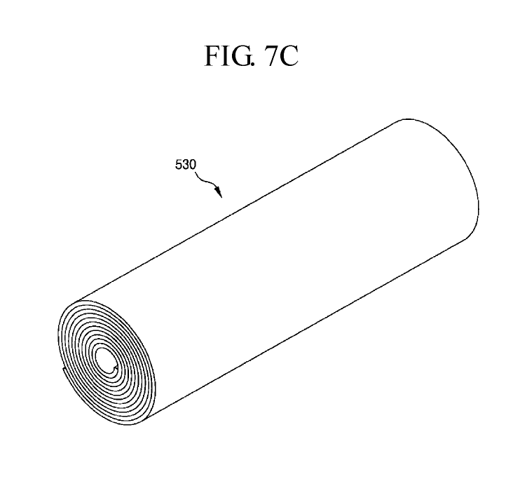

As shown in FIG. 7A, according to an assembly shape of the filter module, the filter module is implemented into a flat plate-like filter module 510 that is formed by laminating a porous ion-exchange membrane with one or both of a nonwoven fabric and a polymer nanofiber web, or that is formed by repeatedly laminating the porous ion-exchange membrane, in which the porous ion-exchange membrane is formed by accumulating nanofibers obtained by electrospinning an ion-exchange solution.

In addition, as shown in FIG. 7B, according to another assembly shape of the filter module, the filter module is implemented into a pleat-like filter module 520 that is configured to comprise a porous ion-exchange membrane that is formed by accumulating nanofibers 101 obtained by electrospinning an ion-exchange solution, a tubular body with a throughhole 521 formed therein, and pleats that are formed on side walls of the throughhole 521 and an outer circumferential surface of the tubular body.

Here, the tubular body has a length greater than the diameter thereof. In some embodiments of the present invention, a plurality of grooves 101a may be formed in the inner side wall of the throughhole 521, and pleated shapes may be made on the inner side wall of the throughhole 521 by the plurality of grooves 101a. In this case, the plurality of grooves 101a may be formed in at least one pattern shape selected from among a straight linear pattern, a curved pattern, a mixed pattern of the straight linear pattern and the curved pattern, a polygonal pattern, a grid-like pattern, a dot-like pattern, a rhombic pattern, a parallelogram pattern, a mesh-like pattern, a striped -like pattern, a cross pattern, a radial pattern, a circular pattern, and a mixed pattern of a plurality of patterns selected from among the straight linear pattern, the curved pattern, the mixed pattern of the straight linear pattern and the curved pattern, the polygonal pattern, the grid-like pattern, the dot-like pattern, the rhombic pattern, the parallelogram pattern, the mesh-like pattern, the striped-like pattern, the cross pattern, the radial pattern, and the circular pattern.

In addition, the tubular body is formed of a porous membrane that is formed by accumulating nanofibers obtained by electrospinning an ion-exchange solution.

In addition, as shown in FIG. 7C, according to still another assembly shape of the filter module, the filter module is implemented into a spirally wound type filter module that is configured to have a spiral structure that is formed by spirally winding a structure that is formed by laminating a porous ion-exchange membrane with one or both of a nonwoven fabric and a polymer nanofiber web, or by spirally winding the porous ion-exchange membrane, in which the porous ion-exchange membrane is formed by accumulating nanofibers obtained by electrospinning an ion-exchange solution. That is, the filter module 530 is assembled in a spirally wound type.

As described above, the present invention has been described with respect to particularly preferred embodiments. However, the present invention is not limited to the above embodiments, and it is possible for one of ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

The present invention may provide an ion-exchange membrane that is formed by accumulating nanofibers of an ion-exchange material obtained by electrospinning an ion-exchange solution, to thereby perform a surface filtration achieved in a surface layer and a depth filtration achieved in an inner layer, and filter out particular ions of a chemical material included in water to be treated by using the ion-exchange material of the nanofibers

1. An ion-exchange membrane comprising: a porous membrane that is formed by accumulated nanofibers which are obtained by electrospinning an ion-exchange solution; or a non-pore membrane that is formed by accumulated liquid droplets which are obtained by electrospraying an ion-exchange solution.

2. The ion-exchange membrane of claim 1, wherein the ion-exchange solution comprises a negative ion exchanger or a positive ion-exchanger.

3. The ion-exchange membrane of claim 1, wherein the porous membrane comprises a number of fine pores formed between the nanofibers.

4. The ion-exchange membrane of claim 1, wherein the porous membrane or the non-pore porous membrane is laminated with one or both of a nonwoven fabric and a polymer nanofiber web.

5. The ion-exchange membrane of claim 1, wherein the porous membrane or the non-pore porous membrane is interposed between a first polymer nanofiber web and a second polymer nanofiber web.

6. A filter module comprising: a porous ion-exchange membrane that is formed by accumulated nanofibers which are obtained by electrospinning an ion-exchange solution; a tubular body with a throughhole formed therein; and pleats that are formed on side walls of the throughhole and an outer circumferential surface of the tubular body.

7. The filter module of claim 6, wherein a plurality of grooves are formed in the side wall of the throughhole, and the pleats are made in the side wall of the throughhole by the plurality of grooves.

8. The filter module of claim 7, wherein the plurality of grooves are formed in at least one pattern shape selected from among a straight linear pattern, a curved pattern, a mixed pattern of the straight linear pattern and the curved pattern, a polygonal pattern, a grid-like pattern, a dot-like pattern, a rhombic pattern, a parallelogram pattern, a mesh-like pattern, a striped-like pattern, a cross pattern, a radial pattern, a circular pattern, and a mixed pattern of a plurality of patterns selected from among the straight linear pattern, the curved pattern, the mixed pattern of the straight linear pattern and the curved pattern, the polygonal pattern, the grid-like pattern, the dot-like pattern, the rhombic pattern, the parallelogram pattern, the mesh-like pattern, the striped-like pattern, the cross pattern, the radial pattern, and the circular pattern.

9. A filter module that is formed by spirally winding a structure that is formed by a lamination of a porous ion-exchange membrane with one or both of a nonwoven fabric and a polymer nanofiber web, or that is configured to have a spiral structure which is made by spirally winding of the porous ion-exchange membrane, in which the porous ion-exchange membrane is formed by accumulated nanofibers which are obtained by electrospinning an ion-exchange solution.
